(19) United States
(12) Patent Application Publication
(10) Pub. No.: US 2025/0173572 A1
(43) Pub. Date: May 29, 2025

(54) METHODS TO PRUNE NEURAL NETWORKS

(71) Applicant: TEXAS INSTRUMENTS INCORPORATED, Dallas, TX (US)

(72) Inventors: Parakh Agarwal, Ghaziabad (IN); Manu Mathew, Bangalore (IN); Pramod Swami, Bangalore (IN); Varun Tripathi, Gurgaon (IN)

(21) Appl. No.: 18/951,875

(22) Filed: Nov. 19, 2024

(30) Foreign Application Priority Data
Nov. 24, 2023 (IN) 202341079790

(51) Int. Cl. G06N 3/082

(52) U.S. Cl. CPC G06N 3/082

(57) ABSTRACT

Various embodiments of the present disclosure relate to pruning the data of a neural network, and in particular, to removing the unnecessary weights from the various channels of the neural network. In one example embodiment, a technique for pruning the weights of a neural network is provided. The technique first includes identifying weights to prune from a channel of the neural network based on a sparsity target and a weight threshold. Once identified, the technique includes determining a pruning factor for pruning the identified weights based on a current training epoch, an initial training epoch, a final training epoch, and a desired pruning pace. Next, the technique includes, over multiple training epochs, reducing each of the identified weights by multiplying the identified weights by the pruning factor. Finally, the technique includes removing the identified weights from the channel that have been reduced to below a threshold value.

### CROSS-REFERENCE TO RELATED APPLICATIONS

This application is related to, and claims the benefit of priority to, India Provisional Patent Application No. 202341079790, filed on Nov. 24, 2023, and entitled “Soft Pruning to Generate Faster Deep Neural Networks”, which is hereby incorporated by reference in its entirety.

### TECHNICAL FIELD

Aspects of the disclosure are related to the field of computing hardware and software and more particularly to the pruning of neural networks.

### BACKGROUND

Pruning describes a technique, commonly utilized in machine learning applications, for reducing the size, and in turn the complexity, of trained neural networks. For example, prior to the deployment of a network, the weight values employed by the network may be analyzed to identify which weight values are deemed unnecessary for executing the task the network has been trained to perform. Once identified, the unnecessary weight values may be removed (i.e., pruned) from the network by either setting or reducing the unnecessary weight values to zero over a series of multiple training epochs.

Currently, various techniques exist to prune a neural network, including N: M structured pruning, and channel structured pruning. N: M structured pruning is representative of a pruning technique for removing weight values from specific parts of the network. More specifically, N: M structured pruning describes a technique for pruning N amount of weights from M consecutive weights. Alternatively, channel structured pruning describes a technique for pruning entire channels of weights from a neural network. For example, a node of a network may be reduced from five channels to three channels via channel structured pruning.

Problematically, current techniques for pruning neural networks are prone to accuracy loss due to the nature in which the weights are removed. For example, when pruning a network, the unnecessary weights may either be set to zero or reduced to zero. Setting the weights to zero is representative of a hard-masking technique where each of the unnecessary weights are multiplied by zero over multiple training epochs. Consequently, hard-masking techniques may lead to accuracy degradation of the network, as a weight that was originally deemed unnecessary may be proven to be required for the network to perform a designated task once the weight has been set to zero.

Alternatively, reducing the weights to zero is representative of a soft-masking technique where the unnecessary weights are multiplied by a learned constraint which slowly reduces the weights closer to zero over multiple training epochs. It should be noted that, in some applications which utilize soft-masking techniques, the number of weights which are reduced to zero increases as the number of training epochs increases. For example, during a first training epoch, a first set of weights may be multiplied by the learned constraint, and then, during a next training epoch, the first set of weights and a second set of weights may be multiplied by the learned constraint.

Consequently, such applications fail to allow a user to designate a desired sparsity at which to prune the network to, and as a result, may become very difficult to calibrate values to attain particular sparsity. Furthermore, current techniques for pruning neural networks (i.e., hard-masking and soft-masking) fail to allow the user to designate a pace at which to prune the network, which may again lead to accuracy degradation.

### SUMMARY

Disclosed herein is technology, including systems, methods, and devices for pruning the data of a neural network. Pruning describes a technique, commonly utilized in machine learning applications, for reducing the size and complexity of trained neural networks. For example, prior to the deployment of a network, the unnecessary weight values from the various channels of the network may be removed to reduce the computational load for when the network is deployed. In various implementations, a technique for pruning the weights of a neural network is provided.

In one example embodiment, the technique first includes identifying weights to prune from a channel of a neural network based on a sparsity target and a weight threshold. The sparsity target is representative of a value which determines the percentage of weights to prune from the channel, while the weight threshold is representative of a value which is generated based on the sparsity target. For example, if the sparsity target is equal to 60%, then the weight threshold is representative of a number which is greater than 60% of the weights from the channel, but less than or equal to 40% of the weights from the channel. In an implementation, the sparsity target is representative of user input, and the weight threshold is representative of a value generated based on the provided user input.

Next, the technique includes determining a pruning factor for pruning the identified weights. The pruning factor is representative of a dynamic value which is applied to the identified weights over multiple training epochs. In an implementation, the pruning factor is representative of a number that is greater than or equal to zero and less than or equal to one, and is determined based on a current training epoch, an initial training epoch, a final training epoch, and a desired pruning pace.

Finally, the technique includes reducing each of the identified weights over multiple training epochs using the pruning factor. For example, the technique may include, over each of the multiple training epochs, multiplying each of the identified weights by the pruning factor. In an implementation, the technique further includes removing weights which have been reduced to below a threshold value. For example, the technique may include, over the multiple training epochs, identifying the weights which have fallen below a threshold value and setting the weights equal to zero.

This Summary is provided to introduce a selection of concepts in a simplified form that are further described below in the Technical Disclosure. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in an implementation.

FIG. 2 illustrates a pruning method in an implementation.

FIGS. 3A and 3B illustrate a neural network in an implementation.

FIG. 4 illustrates an operational scenario in an implementation.

FIG. 5 illustrates another pruning method in an implementation.

FIG. 6 illustrates a pruning graph in an implementation.

FIG. 7 illustrates a results table in an implementation.

FIGS. 8A-8C illustrate another operational scenario in an implementation.

FIG. 9 illustrates a channel pruning method in an implementation.

FIG. 10 illustrates another results table in an implementation

FIG. 11 illustrates a computing system suitable for implementing the various operational environments, architectures, processes, scenarios, and sequences discussed below with respect to the other Figures.

### DETAILED DESCRIPTION

Technology is disclosed herein for pruning the data of a neural network which reduces the size of the network while preserving the accuracy of the network. Pruning describes a technique for removing unnecessary or ineffectual weight values (or even an entire node) from a trained neural network. For example, after training a neural network to perform a designated task, the weight values of the network may be analyzed to determine which weight values are necessary for performing the task of the network, and which weight values are not. The unnecessary weight values may then be removed from the network by either setting or reducing the unnecessary weight values to zero over multiple training epochs. Once removed, the pruned neural network may be retrained based on its sparsified number of weight values to optimize the network and ensure the network is still performing as expected.

Existing methods for pruning a neural network may either apply hard-masking techniques or soft-masking techniques. Hard-masking techniques are representative of pruning methods which set the unnecessary weight values to zero over a series of multiple training epochs. For example, in applications which employ hard-masking techniques, a particular ratio of unnecessary weight values are set to zero in each training epoch while the network is allowed to train over the multiple training epochs. Consequently, incrementally setting the weights to zero may lead to accuracy degradation of the network, since a weight value originally deemed as unnecessary may be proven to be required for the network to perform a designated task.

Alternatively, soft-masking techniques are representative of pruning methods which reduce the unnecessary weight values closer to zero over a series of multiple training epochs. For example, in applications that utilize soft-masking techniques, the unnecessary weight values may be multiplied by a learned constraint which slowly reduces the unnecessary weight values to zero over each training epoch, such that the number of weight values that are reduced increases as the number of training epochs increases. Consequently, current soft-masking techniques fail to allow the user to provide input on the constraint at which to prune by, thusly removing control from the user to prune the network to a desired sparsity. In contrast, disclosed herein is a new technique for pruning the weight values of a neural network which prunes the weight values (e.g., based on user input) while preserving the accuracy of the network, and by design, reduces the computational workload and memory bandwidth of the network for when the network is deployed.

In one example embodiment a computer-readable medium having executable instructions related to the pruning of neural networks is provided. The instructions are configured to be executed by processing circuitry, such that when executed, the instructions cause the processing circuitry to prune the weights from the channels of a neural network. For the purposes of explanation, a singular channel will be discussed herein. This is not meant to limit the applications of the proposed technology, but rather to provide an example.

In an implementation, the program instructions first cause the processing circuitry to identify weights to prune from the channel. For example, the program instructions may cause the processing circuitry to determine which weights to prune from the channel based on a sparsity target and a weight threshold for the channel. The sparsity target is representative of a percentage value which indicates the percentage of weights to be removed from the channel, while the weight threshold is representative of a number which reflects the percentage value of the sparsity target. For example, if the sparsity target is equal to 90%, then the weight threshold is representative of a number which is greater than 90% of the weights from the channel, but less than or equal to the remaining 10%, e.g., the 90th percentile of the weight values. In an implementation, the sparsity target is representative of user input, while the weight threshold is representative of a value generated based on the provided user input. However, the sparsity target can be a preset value and/or an internally generated value, and not necessarily based on user input.

Next, the program instructions cause the processing circuitry to determine a pruning factor for pruning the weights of the channel. The pruning factor is representative of a dynamic value which is used to reduce the identified weights closer to zero over multiple training epochs. In an implementation, the pruning factor is representative of a number which is greater than or equal to zero but less than or equal to one, and is generated based on a current training epoch, an initial training epoch, a final training epoch, and a desired pace. The desired pace describes the speed at which the processing circuitry is configured to prune the network. In an implementation, the desired pace is representative of user input.

Finally, the program instructions cause the processing circuitry to reduce each of the identified weights over multiple training epochs using the pruning factor. For example, the program instructions may cause the processing circuitry to, during a first training epoch, multiply each of the identified weights by the current pruning factor. Once complete, the program instructions may then cause the processing circuitry to, during the second training epoch, multiply each of the identified weights by the updated pruning factor. Meaning that, as the number of training epochs increases, the processing circuitry is configured to, for each training epoch, determine the pruning factor to multiply the weights by and multiply the weights by said pruning factor. As a result, for each training epoch, the identified weights are reduced by a percentage value, such that the percentage at which the weights are reduced by increases for each training epoch.

In an implementation, the program instructions cause the processing circuitry to continue to reduce each of the identified weights until the weights have sufficiently approached the zero bound (e.g., fall below a second threshold value). Once below, the program instructions cause the processing circuitry to remove the weights which have fallen below the second threshold value. For example, the program instructions may cause the processing circuitry to set the weights to zero. In another implementation, the program instructions cause the processing circuitry to continue to reduce each of the identified weights until the identified weights are equal to zero. In either case, after removing the identified weights from the channel, the program instructions cause the processing circuitry to retrain the network with the sparsified number of weights.

In another example embodiment, the instructions further cause the processing circuitry to prune channels of weights from the node families of the neural network. A node family is representative of a collection of nodes which rely upon each other to form an output, such that each node within the family comprises multiple channels which correspond to the channels of the other nodes within the family. For example, a node family may be representative of three nodes each comprising five channels, such that the first two nodes are representative of input nodes, and the third node is representative of a summation node which is configured to sum the data of the input nodes.

In an implementation, to prune the channels of a node family, the program instructions first cause the processing circuitry to generate a net weight matrix for each corresponding channel in the node family. For example, if the node family includes seven corresponding channels, then the processing circuitry is configured to generate seven net weight matrices for each of the corresponding channels. Next, the program instructions cause the processing circuitry to select the corresponding channels with the smallest net weight matrix and prune the selected corresponding channels. For example, the program instructions may cause the processing circuitry to set the weight values of each channel of the corresponding channels to zero. Once set, the program instructions cause the processing circuitry to retrain the network with the sparsified number of channels.

Advantageously, the proposed technology reduces the size of trained neural networks and in turn reduces the computational workload for when the network is deployed. As a result, the proposed technology improves the latency of neural networks during inference, while reducing the memory requirements of the networks. Furthermore, the proposed technology allows a user to provide input (e.g., sparsity target and/or desired pace) on the method in which a network is pruned, thereby allowing the user to fine-tune the network for their specific hardware needs and other considerations. In contrast, existing approaches for pruning neural networks fail to provide a configurable framework to the user. In addition, when pruning out channels of weights, the proposed technology takes corresponding channels within a node family into consideration, thereby providing an optimally fast network.

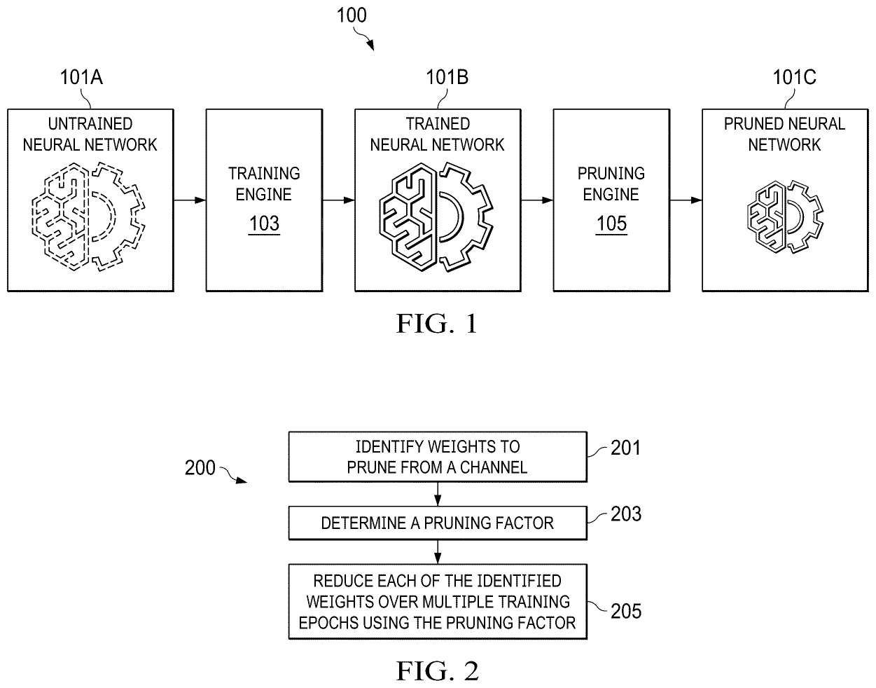

Now turning to the figures, FIG. 1 illustrates operating environment 100 in an implementation. Operating environment 100 is representative of an example environment configurable to prune a trained neural network. Pruning describes a technique for reducing the size of a trained neural network by minimizing the number of weights which are employed by the network to perform a designated task. Operating environment 100 may be implemented to prune a variety of networks, including convolutional neural networks (CNNs), artificial neural networks (ANNs), recurrent neural networks (RNNs), and other deep neural networks (DNNs) of the like. Furthermore, the networks pruned by operating environment 100 may be implemented in a variety of use cases, such as automotive, industrial, robotics, building automation, language processing, power electronics, autonomous systems, arc detection, computer vision, image processing, audio processing, or another application of the like. Operating environment 100 includes, but is not limited to, untrained neural network 101A, training engine 103, trained neural network 101B, pruning engine 105, and pruned neural network 101C.

Untrained neural network 101A is representative of an untrained network that includes a series of interconnected nodes that are organized into the various layers of the network. For example, untrained neural network 101A may comprise multiple layers, including an input layer, one or more hidden layers, and an output layer. The input layer represents one or more nodes configured to receive the input data to the network. For example, if untrained neural network 101A will be trained to perform image classification, then the nodes of the input layer may be representative of nodes configured to receive image data.

In an implementation, the number of nodes within the input layer is equal to the number of input features within the input data. For example, if the input data is representative of an image comprising 32 pixels, then the input layer of untrained neural network 101A is representative of a layer comprising 32 nodes. Output of the input layer is provided as input to the hidden layers of untrained neural network 101A.

The hidden layers of untrained neural network 101A are representative of a series of nodes configured to extract various features from the input data. For example, if untrained neural network 101A will be trained to perform image classification, then the nodes of the hidden layers may be configured to extract features related to depth, edges, colors, and the like within the input data. Output of the hidden layers is supplied as input to the output layer of untrained neural network 101A.

The output layer of untrained neural network 101A represents one or more nodes configured to form the output of the network. For example, if untrained neural network 101A will be trained to perform image classification, then the output of the output layer may include a classification for the input image.

In an implementation, each node of untrained neural network 101A includes multiple channels for analyzing the various dimensions within the input data. For example, if the input data is representative of a red-green-blue (RGB) image, then each node of untrained neural network 101A includes at least three channels, such that the first channel is representative of a channel configured to process red image data, the second channel is representative of a channel configured to process blue image data, and the third channel is representative of a channel configured to process green image data.

In an implementation, to process the various dimensions of the input data, each channel of untrained neural network 101A includes weights which are applied to the input data. For example, if an input node of the network is configured to receive a pixel from an RGB image, then the input node may be configured to apply a first channel weight to the red image data of the pixel, a second channel weight to the green image data of the pixel, and a third channel weight to the blue image data of the pixel. In an implementation, prior to the training of untrained neural network 101A, the channels of the network are initialized with random weights. Once initialized, untrained neural network 101A may be supplied as input to training engine 103.

Training engine 103 is representative of software, hardware, firmware, or a combination thereof configured to train a neural network to perform a designated task. For example, training engine 103 may be representative of a central processing unit (CPU), application-specific integrated circuit (ASIC), digital signal processor (DSP), microcontroller unit (MCU), graphics processing unit (GPU), tensor processing unit (TPU), or another general-purpose processor (GPP) of the like configured to train a neural network to perform image classification, object detection, image segmentation, or another task of the like. In an implementation, training engine 103 is representative of circuitry configured to determine the appropriate weights to be employed by a network. For example, training engine 103 may be configured to generate weights for the channels of untrained neural network 101A. Output of training engine 103 includes trained neural network 101B.

Trained neural network 101B represents the trained version of untrained neural network 101A, such that the weights employed by trained neural network 101B are representative of values which allow trained neural network 101B to accurately perform a designated task. For example, if untrained neural network 101A is trained to perform object detection, then the weights of trained neural network 101B are representative of values which allow the network to accurately detect an object. In an implementation, trained neural network 101B is provided as input to pruning engine 105.

Pruning engine 105 is representative of software, hardware, firmware, or a combination thereof configured to prune the weights of a trained neural network. For example, pruning engine 105 may be representative of a CPU, ASIC, DSP, MCU, GPU, TPU, or another GPP of the like configured to identify which weights are unnecessary for trained neural network 101B to perform its designated task, and in response, remove the identified weights from the network. Meaning that, pruning engine 105 is representative of circuitry configured to reduce/set the unnecessary weights of trained neural network 101B to zero.

In an implementation, to prune the data of trained neural network 101B, pruning engine 105 is configured to collect user input related to the method in which to prune the network. For example, a user may provide a desired sparsity at which to prune the network to, and a desired pace at which the network is pruned by, later discussed in detail with reference to FIG. 2. Output of pruning engine 105 includes pruned neural network 101C.

Pruned neural network 101C represents the pruned version of trained neural network 101B. For example, pruned neural network 101C may represent a sparsified version of trained neural network 101B, such that pruned neural network 101C includes a percentage of the weights from trained neural network 101B. In an implementation, prior to the deployment of pruned neural network 101C, pruned neural network 101C is provided as input to training engine 103 to cause training engine 103 to retrain the network based on the sparsified amount of weights. For example, after pruning engine 105 prunes 60% of the weights from trained neural network 101B, pruning engine 105 may output pruned neural network 101C to training engine 103 to cause training engine 103 to train pruned neural network 101C with the remaining 40% of the weights.

FIG. 2 illustrates pruning method 200 in an implementation. Pruning method 200 is representative of software for pruning the weights from a channel of a trained neural network. Pruning method 200 may be implemented in the context of program instructions that, when executed by a suitable computing system, direct the processing circuitry of the computing system to operate as follows, referring parenthetically to the steps in FIG. 2. For the purposes of explanation, pruning method 200 will be explained with the elements of FIG. 1. This is not meant to limit the applications of pruning method 200, but rather to provide an example.

To begin, pruning engine 105 identifies weights to prune from a channel of a node from trained neural network 101B (step 201). For example, pruning engine 105 may identify weights to prune from a channel of an input node from trained neural network 101B. In an implementation, to identify the weights to prune from the channel, pruning engine 105 is configured to determine a weight threshold for pruning the weights based on a desired sparsity target. The sparsity target is representative of a percentage value at which the weights of the channel should be pruned to. For example, if the sparsity target is equal to 95%, then pruning engine 105 is configured to remove 95% of the weights from the channel.

In an implementation, the sparsity target is representative of user provided input. For example, pruning engine 105 may be configured to receive a desired sparsity target for a channel of trained neural network 101B from an associated user, and in response, generate a weight threshold for pruning the weights of the channel. The weight threshold is representative of a value which reflects the percentage of the sparsity target. For example, if the sparsity target is equal to 75%, then the weight threshold is representative of a number which is greater than 75% of the weights from the channel, but less than or equal to the remaining 25% of the weights. Additional example details of sparsity targets can be found in commonly assigned U.S. Pat. No. 11,915,117, entitled “Reduced Complexity Convolution for Convolutional Neural Networks,” filed May 24, 2021, which is incorporated by reference in its entirety.

Next, pruning engine 105 is configured to determine a pruning factor for pruning the identified weights (step 203). The pruning factor is representative of a dynamic value which is used to reduce the identified weights closer to zero over multiple training epochs. In other words, the pruning factor is representative of a soft mask which is applied to the identified weights to cause the identified weights to reduce closer to zero as the number of training epochs increases. In an implementation, the pruning factor is representative of a number which is greater than or equal to zero, and less than or equal to one, and is generated based on a current training epoch, an initial training epoch, a final training epoch, and a desired pace. Meaning that, the pruning factor changes over the course of the multiple training epochs.

In an implementation, to generate the pruning factor, pruning engine 105 is configured to receive a desired pace at which to prune the weights by from an associated user, such that the desired pace describes the speed at which pruning engine 105 is allowed to prune at. For example, the user may request pruning engine 105 to prune the network linearly, or non-linearly. In addition to the desired pace, pruning engine 105 may further be configured to receive an initial training epoch and a final training epoch from the associated user. For example, the user may designate the training epoch to begin pruning, and the training epoch to terminate pruning.

Finally, pruning engine 105 is configured to reduce each of the identified weights over multiple training epochs using the pruning factor (step 205). For example, pruning engine 105 may be configured to, prior to the initial training epoch, calculate the pruning factor for the initial training epoch, and during the initial training epoch, multiply each of the identified weights by the pruning factor. Then on the next training epoch, pruning engine 105 may recalculate the pruning factor and multiply each of the identified weights by the updated pruning factor. In an implementation, pruning engine 105 continues to reduce each of the identified weights by the pruning factor until the weights fall below a second threshold value. Once below, pruning engine 105 is configured to remove the weights which have fallen below the second threshold value from the channel. For example, pruning engine 105 may be configured to apply a hard mask to the weights which have fallen below the second threshold value by multiplying the weights by zero. Once removed, pruning engine 105 is configured to determine whether to prune a next channel of the network.

In an implementation, pruning engine 105 is configured to execute pruning method 200 for each channel of trained neural network 101B. For example, if trained neural network 101B includes seven nodes, each comprising three channels, then pruning engine 105 may be configured to execute pruning method 200 for each of the 21 channels of trained neural network 101B. In another implementation, pruning engine 105 is configured to execute pruning method 200 for the channels of trained neural network 101B until trained neural network 101B reaches a target sparsity. For example, an associated user may designate that trained neural network 101B needs to be pruned to 50%. In an implementation, once each channel of trained neural network 101B has been pruned, or trained neural network 101B has reached a target sparsity, pruning engine 105 may output pruned neural network 101C to training engine 103. In response, training engine 103 may train pruned neural network 101C based on the sparsified number of weights.

Advantageously, pruning method 200 is representative of a technique for pruning a neural network which provides a configurable framework to the user. As a result, a user may prune a neural network to meet their specific hardware needs. For example, if a user wishes to deploy a trained neural network on a device with limited memory bandwidth, then the user may configure pruning engine 105 to prune the trained neural network to fit the memory requirements of the device. Furthermore, pruning method 200 reduces the size of trained neural networks, thereby reducing the computational workload of the network for when the network is deployed.

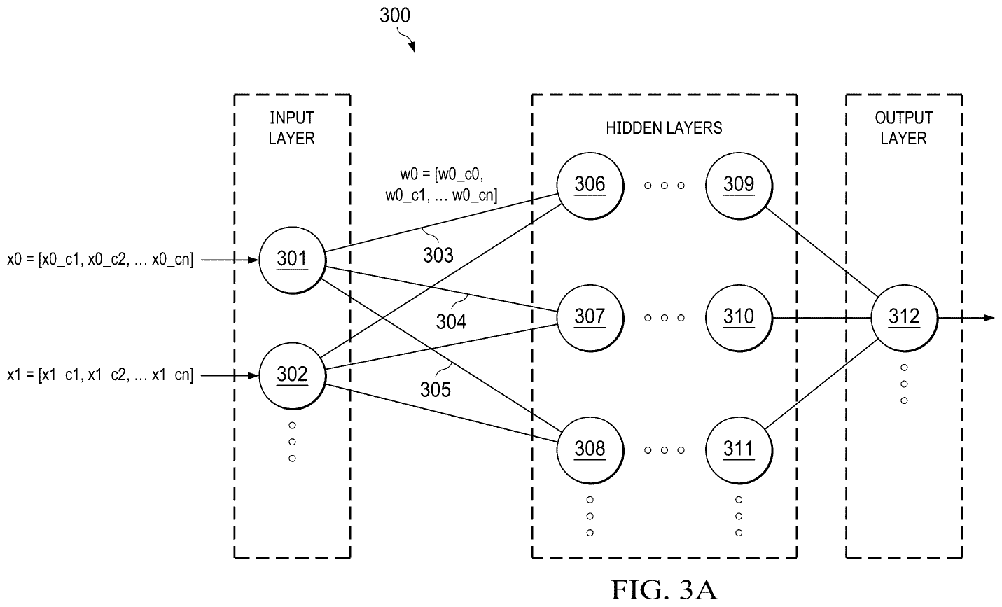

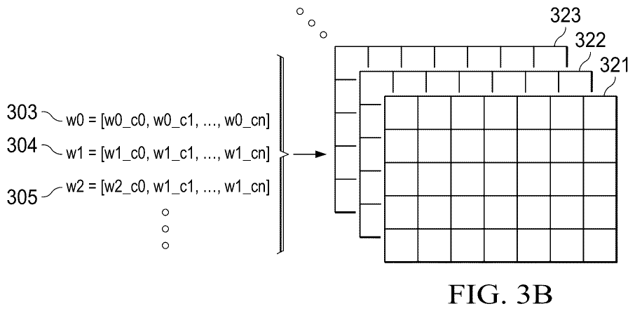

FIG. 3A illustrates neural network 300 in an implementation. Neural network 300 is representative of a trained neural network (e.g., trained neural network 101B) configured to perform a designated task. For example, neural network 300 may be representative of a CNN, ANN, RNN, or another DNN of the like configured to perform object detection, image classification, image segmentation, or another task of the like. Neural network 300 includes, but is not limited to, input nodes 301 and 302, hidden nodes 306, 307, 308, 309, 310, and 311, and output node 312.

Input nodes 301 and 302 represent the processing units from the input layer of neural network 300, such that the input layer represents the first layer of the network and is configured to receive the input data for executing the task of neural network 300. For example, if neural network 300 is configured to perform image classification, then the data processed by the input layer of the network may be representative of image data. In an implementation, the number of nodes within the input layer is equal to the number of input features within the input data. For example, if the input data is representative of an image matrix comprising 64 pixels, then the input layer to neural network 300 is representative of a layer which includes 64 input nodes, but for the purposes of explanation, input nodes 301 and 302 will be discussed herein.

Input to input nodes 301 and 302 include feature vectors which respectively correspond to an input feature within the input data. For example, if the input data is representative of an RGB image, then input to input node 301 may include an input feature vector (i.e., x0= [x0_c0, x0_c1, . . . , x0_cn]) which captures the red, green, and blue image data of a first pixel within the RGB image, while input to input node 302 may include an input feature vector (i.e., x1=[x1_c0, x1_c1, . . . , x1_cn]) which captures the red, green, and blue image data of a second pixel within the RGB image. Meaning that, each input feature vector is representative of a vector which captures the various dimensions of the input data.

In an implementation, input nodes 301 and 302 include multiple channels for processing the various dimensions of an input feature vector. For example, if the input feature vectors are representative of vectors storing RGB data of an associated pixel, then input nodes 301 and 302 each comprise three channels for processing the red, green, and blue image data of the associated pixel. In an implementation, to process the data of an input feature vector, the channels of input nodes 301 and 302 include various weights which are applied to the entries of the input feature vectors. For example, input node 301 may be configured to multiply each entry of an input feature vector by weights 303, 304, and 305.

Weights 303, 304, and 305 are representative of vectors or matrices which store channel weights generated during the training phase of neural network 300. For example, weight 303 may be representative of a vector (i.e., w0=[w0_c0, w0_c1, . . . , w0_cn]) storing weights to be applied to the various dimensions of the input feature vector. Meaning that, if the input feature vector is representative of a vector storing RGB data of an associated pixel, then weights 303 is representative of a vector storing channel weights to be applied to the red, green, and blue pixel data of the associated pixel. It should be noted that, for the purposes of clarity, weights 303, 304, and 305 are the only weights illustrated herein. This is not meant to limit the applications of the remaining nodes, but rather to provide an example. In an implementation, after applying weights 303, 304, and 305 to the input feature vector, node 301 is configured to respectively provide its output to hidden nodes 306, 307, and 308.

Hidden nodes 306, 307, and 308 are representative of processing units from a hidden layer of neural network 300. A hidden layer is representative of a layer which is in between the input layer and the output layer of the network. It should be noted that neural network 300 comprises multiple hidden layers, each comprising one or more hidden nodes, but for the purposes of explanation, only a select number of hidden layers, and a select number of hidden nodes are illustrated herein.

In an implementation, hidden nodes 306, 307, and 308, as well as hidden nodes 309, 310, and 311 are configured to extract various features from the data related to the task of the network. For example, if neural network 300 is representative of a network configured to perform object detection in the automotive context, then hidden nodes 306, 307, 308, 309, 310, and 311 may include multiple channels for extracting features related to the detection of vehicles, pedestrians, road hazards, street signs, and the like. In an implementation, to extract features related to the task of the network, the channels of hidden nodes 306, 307, 308, 309, 310, and 311 include various weights which are applied to the data. Output of the nodes may then be supplied to the next layer of the network. For example, output of hidden nodes 309, 310, and 311 may be supplied to output node 312.

Output node 312 is representative of a processing unit from the output layer of neural network 300, such that the output layer represents the final layer of the network. In an implementation, output node 312 is configured to form the output of neural network 300 by applying weights to its received input. For example, if neural network 300 is configured to perform image classification, then the channels of output node 312 include weights which allow output node 312 to output a classification of an input image.

In an implementation, the output of output node 312 is provided to a next network. For example, neural network 300 may be representative of a CNN configured to extract features from input data and provide the extracted features to a view transformation engine configured to shift the perspective of the input data from a first perspective to a second perspective (e.g., convert image data from a front view to a top view). It should be noted that the output layer of neural network 300 may include multiple output nodes, but for the purposes of explanation, output node 312 is illustrated herein.

Now turning to the next figure, FIG. 3B illustrates the weight data of input node 301. More specifically, FIG. 3B illustrates weights 303, 304, and 305 in an implementation. Weights 303, 304, and 305 are representative of vectors storing learned parameters from the training phase of neural network 300. As such, weights 303, 304, and 305 are representative of vectors storing the channel weights for the various dimensions of the input data.

In an implementation, the weight data of input node 301 may be represented as a set of matrices, such that each matrix corresponds to a different dimension of the input data. For example, weights 303, 304, and 305 may be formatted such that matrix 321 stores the channel weights of a first dimension (i.e., w0_c0, w1_c0, and w2_c0), matrix 322 stores the channel weights of a second dimension (i.e., w0_c1, w1_c1, and w2_c1), and matrix 323 stores the channel weights of a third dimension (i.e., w0_c2, w1_c2, and w2_c2). It should be noted that, the weight data of input node 301 may be formatted into one or more matrices, but for the purposes of explanation, only matrices 321, 322, and 323 are illustrated herein.

In an implementation, the channel weights stored by matrices 321, 322, and 323 may be analyzed by circuitry configured to prune the weights of input node 301. For example, the channel weights of matrices 321, 322, and 323 may be analyzed by pruning engine 105 to determine which weights are not required or relatively ineffectual for accurately performing the task of neural network 300.

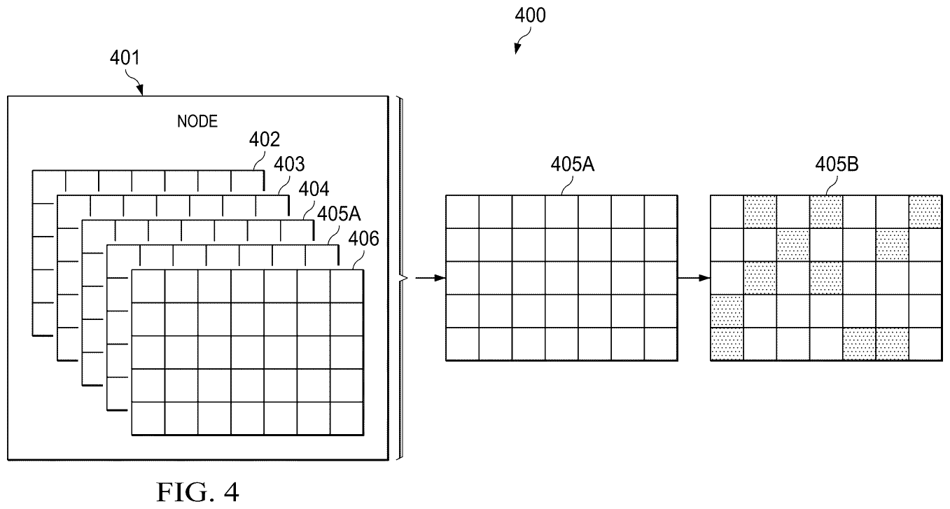

FIG. 4 illustrates operational scenario 400 in an implementation. Operational scenario 400 is representative of a pruning scenario for performing N: M structured pruning. N: M structured pruning describes a technique for pruning N number of weights from M consecutive weights. Operational scenario 400 includes, but is not limited to, node 401.

Node 401 is representative of a processing unit of a neural network configured to perform a designated task. For example, node 401 may be representative of input nodes 301-302, hidden nodes 306-311, or output node 312 of neural network 300. In an implementation, node 401 includes multiple channels for processing various sections of input data. For example, if the input data is representative of an RGB image, then node 401 may include three channels, such that the first channel is configured to process red image data, the second channel is configured to process green image data, and the third channel is configured to process blue image data.

In an implementation, the channels of node 401 include various weights which are applied to the input data. For example, node 401 may include multiple matrices, each configured to store the channel weights of an associated channel. In an implementation, node 401 comprises five channels, each associated with a corresponding channel matrix, including matrix 402, matrix 403, matrix 404, matrix 405A, and matrix 406.

Matrices 402-406 represent matrices storing the channel weights of node 401. For example, matrices 402-406 may be representative of matrices 321-323. In an implementation, processing circuitry associated with operational scenario 400 is configured to identify a channel of node 401 to prune and prune a desired amount of weights from the channel. For example, pruning engine 105 may be configured to analyze matrices 402-406, to identify a matrix to prune, and prune the identified matrix.

In a brief operational example, processing circuitry associated with node 401 is configured to select a matrix to prune from node 401. For example, the processing circuitry may select matrix 405A. Next, the processing circuitry is configured to identify weights to prune from matrix 405A based on a user provided sparsity target. For example, a user associated with operational scenario 400 may designate a desired sparsity at which to prune matrix 405A to, such that the desired sparsity is representative of a percentage which indicates the number of weights the user wishes to remove from the channel. In an implementation, to identify the weights to prune from the channel, the processing circuitry is configured to generate a weight threshold based on the user provided sparsity target. The weight threshold is representative of a value that reflects the percentage of the sparsity target. For example, if the sparsity target is equal to 80%, then the weight threshold is representative of a number which is greater than 80% of the weights stored by matrix 405A, but less than or equal to the remaining 20%. In an implementation, the processing circuitry is configured to identify the weights which are less than the weight threshold and prune the identified weights using a pruning factor.

The pruning factor is representative of a dynamic value that is used to reduce the identified weights closer to zero over a series of multiple training epochs. In an implementation, the pruning factor is representative of a number which is greater than or equal to zero but less than or equal to one, and is generated based on a current training epoch, an initial training epoch, a final training epoch, and a desired pace. The desired pace is representative of user input which describes the speed at which the processing circuitry is allowed to prune the network.

Finally, the processing circuitry is configured to reduce each of the identified weights over multiple training epochs using the pruning factor. For example, the processing circuitry may be configured to, for each training epoch, determine the pruning factor to multiply the identified weights by, and multiply the weights by said pruning factor. As a result, the processing circuitry outputs matrix 405B. Matrix 405B is representative of the pruned version of matrix 405A.

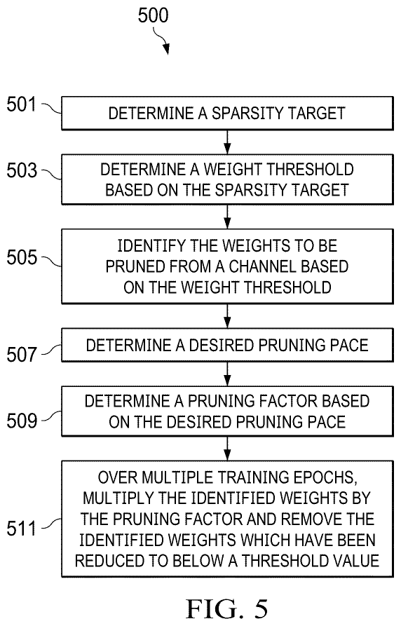

FIG. 5 illustrates pruning process 500 in an implementation. Pruning process 500 is representative of software for pruning the weights from a channel of a trained neural network. For example, pruning process 500 may be representative of pruning method 200 of FIG. 2. Pruning process 500 may be implemented in the context of program instructions that, when executed by a suitable computing system, direct the processing circuitry of the computing system to operate as follows, referring parenthetically to the steps in FIG. 5. For the purposes of explanation, pruning process 500 will be explained with the elements of FIG. 4. This is not meant to limit the applications of pruning process 500, but rather to provide an example.

To begin, processing circuitry associated with node 401 is configured to determine a sparsity target for pruning the weights of matrix 405A (step 501). For example, the processing circuitry may be configured to receive the sparsity target from an associated user. The sparsity target is representative of a percentage which indicates the number of weights the user wishes to remove from matrix 405A.

Next, the processing circuitry is configured to determine a weight threshold for pruning the weights of matrix 405A based on the sparsity target (step 503). For example, if the sparsity target is equal to 75%, then the processing circuitry is configured to generate a value which is greater than 75% of the weights of matrix 405A, but less than or equal to the remaining 25% of the weights. In an implementation, after generating the weight threshold, the processing circuitry is then configured to identify weights to prune from matrix 405A based on the weight threshold (step 505). For example, the processing circuitry may identify the weights which are less than the weight threshold and flag the identified weights as the weights to be pruned from matrix 405A.

Once identified, the processing circuitry is configured to determine a desired pace for pruning the identified weights (step 507). For example, the processing circuitry may be configured to receive the desired pace from an associated user. The desired pace is representative of a value which is greater than or equal to one and indicates the desired speed at which the user wishes to prune the identified weights. In an implementation, the user may instruct the processing circuitry to prune the network linearly, or nonlinearly, via the desired pace.

Next, the processing circuitry is configured to determine a pruning factor based on the desired pace (step 509). The pruning factor is representative of a soft mask which is applied to the identified weights over multiple training epochs. In an implementation, the pruning factor is represented by the following equation:

$$pruning factor = {α}_{i}^{p} , \\ where {α}_{i} = 1. - max ( min ( \frac{{E}_{i} - {E}_{init}}{{E}_{knee}} , 1. ) , 0. ) \qquad ( 1 )$$

Such that in equation (1) αᵢ is representative of a dynamic pruning value, p is representative of the pruning pace, Eᵢ is representative of the current training epoch, Eᵢₙᵢₜ is representative of the training epoch where pruning began, and Eₖₙₑₑ is representative of the training epoch where pruning is terminated.

In another implementation, the pruning factor is represented by the following equation:

$$pruning factor = {α}_{i}^{p} , \\ where {α}_{i} = 1. - max ( min ( \frac{{E}_{i} - {E}_{init}}{{E}_{knee} - {E}_{init}} , 1. ) , 0. ) \qquad ( 2 )$$

Such that in equation (2), αᵢ is representative of a dynamic pruning value, p is representative of the pruning pace, Eᵢ is representative of the current training epoch, Eᵢₙᵢₜ is representative of the training epoch where pruning began, and Eₖₙₑₑ is representative of the training epoch where pruning is terminated.

In either implementation, Eᵢₙᵢₜ and Eₖₙₑₑ may be representative of user provided values. For example, a user associated with the processing circuitry may instruct the processing circuitry to begin pruning the data of matrix 405A on the fifth training epoch (i.e., Eᵢₙᵢₜ=5) and to terminate the pruning on the 60^{th} training epoch (i.e., Eₖₙₑₑ=60).

Finally, over multiple training epochs, the processing circuitry is configured to multiply the identified weights of matrix 405A by the pruning factor and remove the weights which have fallen below a second threshold value (step 511). For example, for each training epoch, the processing circuitry is configured to calculate the pruning factor for the current training epoch and multiply the identified weights by said pruning factor. Then, over the course of the multiple training epochs, the processing circuitry is configured to identify the weights which have fallen below a second threshold value. The second threshold value is representative of a number that provides an indication to the processing circuitry that a weight has been reduced to the point where the weight may be removed from the channel. Meaning that, when a weight falls below the second threshold value, the processing circuitry is configured to set the weight to zero. In other words, the processing circuitry is configured to apply a hard mask to the weight by multiplying the weight by zero. In an implementation, the second threshold value is representative of user provided input. For example, a user may indicate that when a weight falls below 0.0001, the weight may be removed from the channel.

In another implementation, over the multiple training epochs, the processing circuitry is configured to remove weights which are equal to zero. For example, for each training epoch, the processing circuitry is configured to calculate the pruning factor for the current training epoch and multiply the identified weights by said pruning factor. Then, after a certain number of training epochs, the processing circuitry begins removing weights from the channel as the weights are set to zero via the pruning factor.

It should be noted that some applications may instead utilize a second threshold value to remove the identified weights, due to the nature in which the weights are reduced. For example, the pruning factor may cause the identified weights to asymptotically approach zero, but never actually reach zero. In such applications, the processing circuitry is configured to utilize a second threshold value to determine to remove the identified weights from the channel. In an implementation, after removing the identified weights from matrix 405A, the processing circuitry is configured to retrain the network of node 401 with respect to matrix 405B.

Advantageously, pruning process 500 provides a technique for pruning the channels of a neural network which is based on user input. As a result, pruning process 500 is representative of a technique which allows a user to prune a neural network to meet their specific hardware needs. Furthermore, pruning process 500 reduces the size of a trained neural network, thereby reducing the computational workload of the network for when the network is deployed.

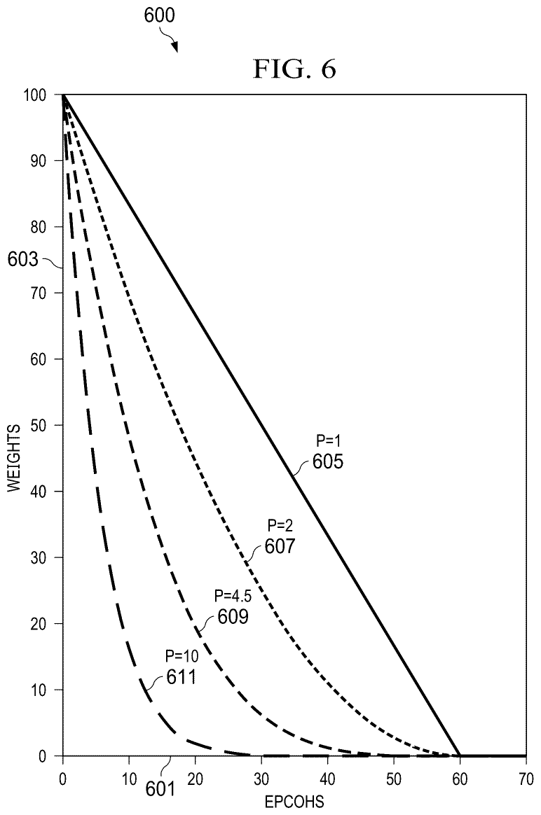

FIG. 6 illustrates pruning graph 600 in an implementation. Pruning graph 600 is representative of a graph which depicts the various paces at which the weights from a channel of a neural network may be pruned. For example, pruning graph 600 may be representative of a graph which depicts the various paces for pruning the weights of matrix 405A. Pruning graph 600 includes, but is not limited to, epochs axis 601 and weights axis 603.

Epochs axis 601 is representative of an axis which depicts the number of training epochs a neural network has undergone, such that a training epoch describes a singular pass through the training data set of a network. Meaning that, during a training epoch, the processing circuitry which prunes the network is configured to process the entirety of the training data set. In an implementation, after each training epoch, the processing circuitry which is configured to prune the network is also configured to adjust the weights which were not selected to be pruned, to ensure the network is accurately performing its designated task.

Weights axis 603 is representative of an axis which depicts the percentage of weights which have been pruned from the channel of a network, such that the weights represented by weights axis 603 represent the weights which have been selected to be pruned. For example, prior to the pruning of matrix 405A, processing circuitry associated with matrix 405A is configured to identify the weights to be pruned from matrix 405A based on a user provided sparsity target and an associated weight threshold. The sparsity target describes the percentage of weights the user wishes to remove from the channel while the weight threshold is representative of a value which matches the percentage of the sparsity target. For example, if the sparsity target is equal to 90%, then the weight threshold is representative of a value which is greater than 90% of the weights of matrix 405A, but less than or equal to the remaining 10% of the weights.

In an implementation, after identifying the weights to be pruned from a channel, the processing circuitry is configured to begin pruning the identified weights over a series of multiple training epochs. For example, to prune matrix 405A, the processing circuitry may employ the following equation:

$${w}^{′} = \{ \begin{matrix}w , & \vert w \vert \geq {w}_{t} \\ {α}_{i}^{p} w , & \vert w \vert < {w}_{t} ; p \geq 1\end{matrix} \qquad ( 3 )$$

Such that in equation (3), w′ is representative of a pruned weight value, w is representative of an example weight value, wₜ is representative of the weight threshold, and αᵢ^{p} is representative of the pruning factor as described in either equations (1) or (2). In other words, the processing circuitry may identify the weights which are less than the weight threshold, and over a series of multiple training epochs, multiply the identified weights by the pruning factor.

In an implementation, prior to the pruning of a channel, the processing circuitry configured to prune the channel receives a desired pace (i.e., p) from an associated user. For example, if the user designates that they wish for the channel weights to be pruned linearly, then the user may set the desired pace equal to one (i.e., p=1) as represented by function output 605. Alternatively, if the user designates that they wish for the channel weights to be pruned non-linearly (e.g., exponentially or parabolically), then the user may set the desired pace to a number which is greater than one (i.e., p>1). For example, the user may set the desired pace as equal to 2, 4.5 or 10 (i.e., p=2, 4.5, or 10), as respectively represented by function outputs 607, 609, and 611.

It should be noted that, since the desired pace is representative of user input, the proposed technology allows the user to select a pace which best suits the network in which they plan to prune. For example, certain networks are better suited to be pruned at a non-linear pruning pace, while other networks are better suited to be pruned at a linear pruning pace.

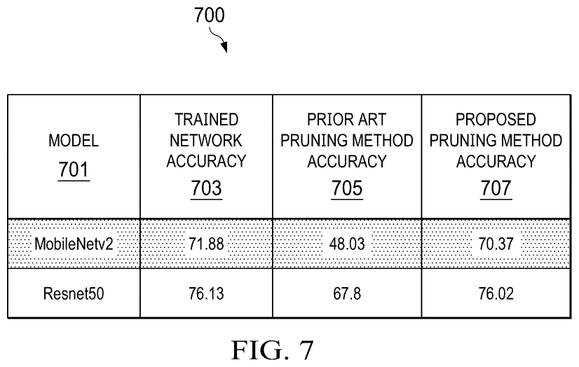

FIG. 7 illustrates results table 700 in an implementation. Results table 700 is representative of a table which depicts the accuracy loss of a network for when the network has been pruned via prior art methodologies versus when the network has been pruned with the methodologies presented herein. More specifically, results table 700 is representative of a table which depicts the accuracy loss of a network which was pruned via N: M structured pruning methodologies, such that the network represented by results table 700 represents a network which underwent 41:64 structured pruning. Results table 700 includes model column 701, trained network accuracy column 703, prior art accuracy column 705, and proposed method accuracy column 707.

Model column 701 is representative of a column which depicts the types of models that associated processing circuitry may be configured to train and prune. For example, in a first implementation, the processing circuitry may be configured to train and prune a MobileNetv2 network. A MobileNetv2 network is representative of a lightweight convolutional neural network which is designed for mobile and embedded vision applications. Alternatively, in a second implementation, the processing circuitry may be configured to train and prune a Resnet50 network. A Resnet50 network is representative of a convolutional neural network which includes 50 layers and is configured to perform image classification. It should be noted that the advantages depicted by results table 700 are not limited to the depicted networks, but for the purposes of explanation, Mobilenetv2 networks and Resnet50 networks will be discussed herein.

In an implementation, prior to the deployment of a MobileNetv2 network or a Resnet50 network, processing circuitry associated with the networks is configured to train the networks to perform a designated task. For example, the processing circuitry may train either network to perform image classification. Once trained, the processing circuitry may evaluate the trained network to determine if the network is accurately performing image classification, as depicted by trained network accuracy column 703.

Trained network accuracy column 703 is representative of a column which stores the accuracy percentage of a trained neural network which has not yet been pruned. The accuracy percentage is representative of a percentage which provides an indication of how accurately a trained neural network is performing a designated task. For example, if a MobileNetv2 network was trained to perform image classification, and the MobileNetv2 network is capable of classifying images 71.88% of the time, then trained network accuracy column 703 is configured to store 71.88% for the MobileNetv2 network. Alternatively, if a Resnet50 network was trained to perform image classification, and the Resnet50 network is capable of classifying images 76.13% of the time, then trained network accuracy column 703 is configured to store 76.13% for the Resnet50 network.

In an implementation, after training a network to perform a designated task, the channel weights employed by the trained network may be evaluated to determine which channel weights may be pruned from the network. Once pruned, the processing circuitry may evaluate the pruned neural network to determine if the network is still accurately performing its designated task, as depicted by prior art accuracy column 705 and proposed method accuracy column 707.

Prior art accuracy column 705 is representative of a column which stores the accuracy percentage of a trained neural network which has been pruned via prior art methodologies. For example, prior art accuracy column 705 may be representative of a column storing the accuracy percentage for a network which was pruned by multiplying the unnecessary channel weights by a learned constraint which slowly reduces the unnecessary channel weights to zero over each training epoch, such that the number of channel weights that are reduced increases as the number of training epochs increases. In an implementation, the accuracy percentage of a trained MobileNetv2 network which was pruned via prior art methodologies decreases to 48.03%, while the accuracy percentage of a Resnet50 network which was pruned via prior art methodologies decreases to 67.8%.

Alternatively, proposed method accuracy column 707 is representative of a column which stores the accuracy percentage of a trained neural network which has been pruned via the proposed methodologies. For example, proposed method accuracy column 707 may be representative of a column storing the accuracy percentage for a network which was pruned via pruning method 200 or pruning process 500. In an implementation, the accuracy percentage of a trained MobileNetv2 network which was pruned via the proposed methodologies decreases to 70.37%, while the accuracy percentage of a Resnet50 network which was pruned via the proposed methodologies decreases to 76.02%.

Advantageously, the proposed methodologies for pruning neural networks provides a technique which minimizes the accuracy loss of trained neural networks as compared to the current prior art methods. As a result, the proposed methodologies provide a method for pruning a trained neural network which reduces the size of the neural network while minimizing the accuracy loss of the network.

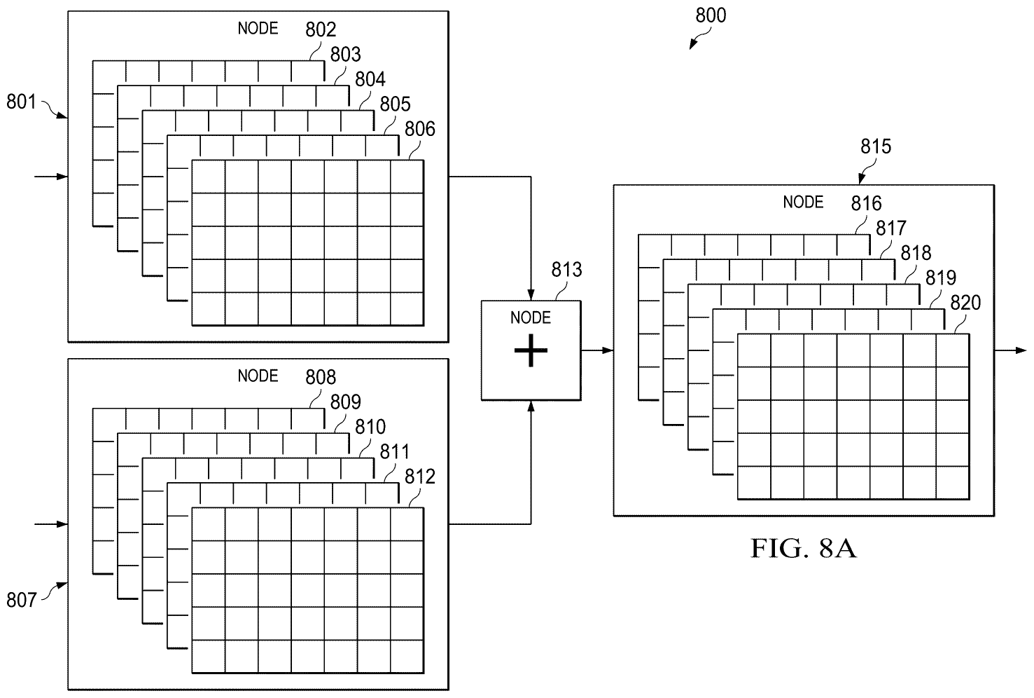

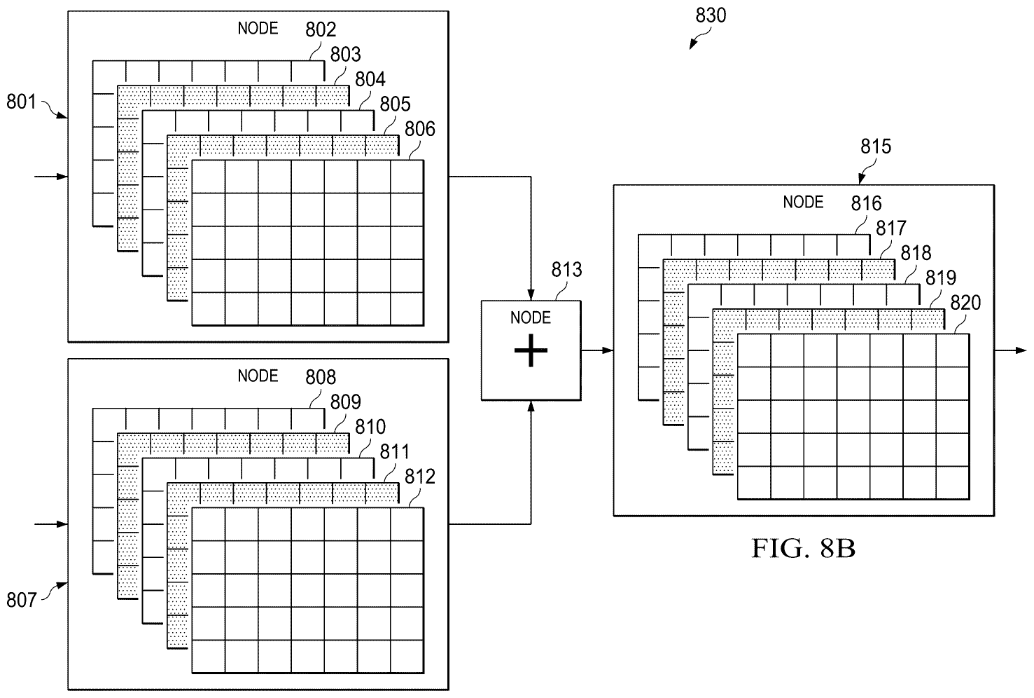

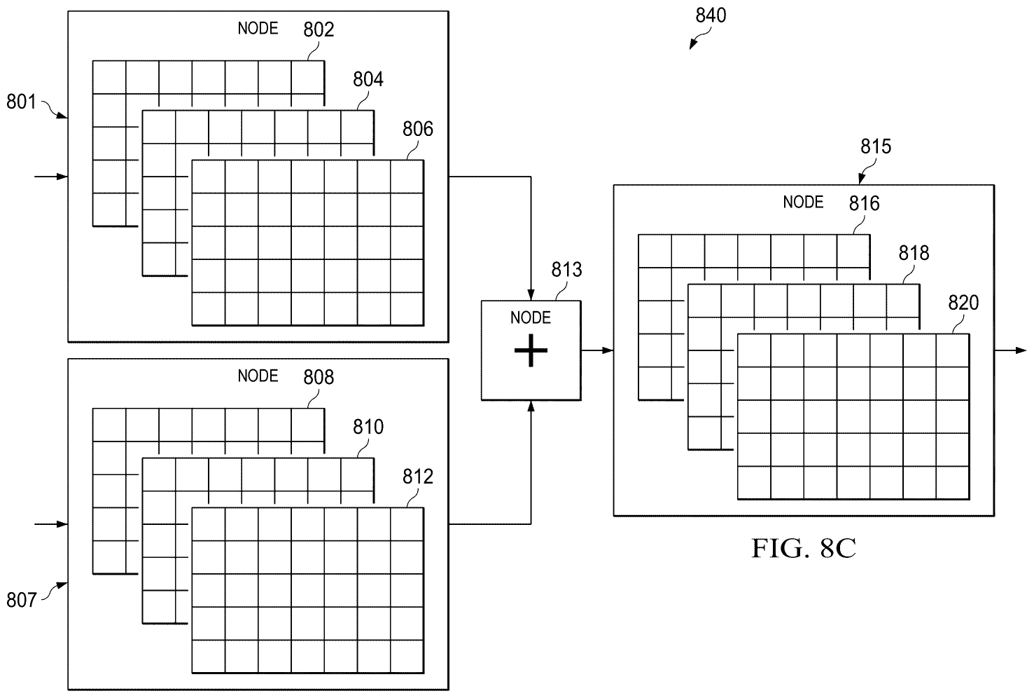

FIGS. 8A-8C illustrate an operational scenario in an implementation. More specifically, FIGS. 8A-8C illustrate multiple stages of a pruning scenario for performing channel structured pruning. Channel structured pruning describes a technique for pruning out channels of weights from the node families of a neural network. Now turning to FIG. 8A, stage 800 is representative of the first stage for performing channel structured pruning. Stage 800 includes node 801, node 807, node 813, and node 815.

Nodes 801, 807, 813, and 815 are representative of processing units from the layers of a neural network. For example, nodes 801, 807, 813, and 815 may be representative of nodes within neural network 300. In an implementation, nodes 801, 807, 813, and 815 represent the nodes of a node family. A node family is representative of a collection of nodes which rely upon each other to form an output. In the context of stage 800, nodes 801 and 807 are representative of the input nodes to node 813, such that node 813 is representative of a summation node configured to sum the output data of nodes 801 and 807 and provide the summed output to node 815.

In an implementation, nodes 801, 807, 813, and 815 include multiple corresponding channels for processing various sections of input data. For example, if the input data is representative of an RGB image, then nodes 801, 807, 813, and 815 may each include three channels, such that the first channel is configured to process red image data, the second channel is configured to process green image data, and the third channel is configured to process blue image data. In an implementation, the channels of nodes 801, 807, 813, and 815 include various weights which are applied to the input data. For example, nodes 801, 807, 813, and 815 may include multiple matrices, each configured to store the channel weights of an associated corresponding channel. In an implementation, nodes 801, 807, and 815 each comprise five corresponding channels that are associated with a corresponding channel matrix, such that the first channel includes matrices 802, 808, and 816, the second channel includes matrices 803, 809, and 817, the third channel includes matrices 804, 810, and 818, the fourth channel includes matrices 805, 811, and 819, and the fifth channel includes matrices 806, 812, and 820.

Matrices 802, 808, and 816 respectively represent the first channel matrix of nodes 801, 807, and 815. Matrices 803, 809, and 817 respectively represent the second channel matrix of nodes 801, 807, and 815. Matrices 804, 810, and 818 respectively represent the third channel matrix of nodes 801, 807, and 815. Matrices 805, 811, and 819 respectively represent the fourth channel matrix of nodes 801, 807, and 815. Matrices 806, 812, and 820 respectively represent the fifth channel matrix of nodes 801, 807, and 815. In an implementation, processing circuitry associated with stage 800 is configured to identify one or more corresponding channels to prune from the node family, and prune the matrices associated with the corresponding channels. For example, the processing circuitry may be configured to generate a net weight matrix for each of the corresponding channels, and prune the matrices associated with the smallest net weight matrix.

In a brief operational example, processing circuitry associated with stage 800 is configured to generate a net weight matrix for each corresponding channel of nodes 801, 807, and 815. For example, the processing circuitry may generate five net weight matrices, such that the first net weight matrix represents the net weight matrix of matrices 802, 808, and 816, the second net weight matrix represents the net weight matrix of matrices 803, 809, and 817, the third net weight matrix represents the net weight matrix of matrices 804, 810, and 818, the fourth net weight matrix represents the net weight matrix of matrices 805, 811, and 819, and the fifth net weight matrix represents the net weight matrix of matrices 806, 812, and 820. Next the processing circuitry is configured to identify one or more corresponding channels to prune based on the smallest net weight matrices.

Now turning to FIG. 8B, stage 830 is representative of a second stage of the pruning scenario. More specifically, stage 830 is representative of a stage for pruning one or more corresponding channels. Stage 830 also includes node 801, node 807, node 813, and node 815.

In a brief operational example, after generating the net weight matrices as explained in stage 800, the processing circuitry is then configured to analyze the data of the net weight matrices to determine which corresponding channels to prune from nodes 801, 807 and 815. For example, the processing circuitry may determine that the second and fourth channels of nodes 801, 807, and 815 are associated with the smallest net weight matrices, and in response, prune matrices 803, 805, 809, 811, 817, and 819 from nodes 801, 807, and 815. In an implementation, to prune a channel matrix from a node, the processing circuitry is configured to apply a hard mask to the matrix by multiplying the matrix by zero. For example, the processing circuitry may multiply the data of matrices 803, 805, 809, 811, 817, and 819 by zero.

Now turning to FIG. 8C, stage 840 is representative of a third stage of the pruning scenario. More specifically, stage 840 is representative of the output stage for pruning one or more corresponding channels. Stage 840 also includes node 801, node 807, node 813, and node 815. In a brief operational example, after pruning the data of nodes 801, 807, and 815 as explained in stage 830, the processing circuitry is then configured to retrain the network based on the sparsified amount of channel weights. For example, after removing the second and fourth channels from nodes 801, 807, and 815, the processing circuitry is configured to retrain the network using the data from the first, third, and fifth channels.

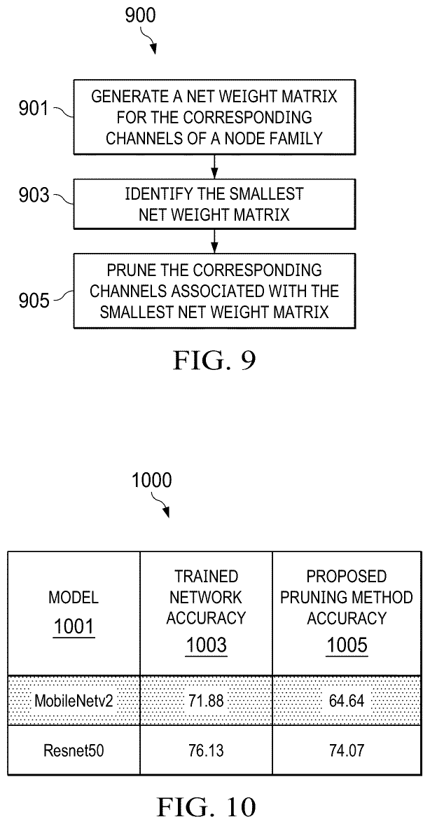

FIG. 9 illustrates channel pruning process 900 in an implementation. Channel pruning process 900 is representative of software for pruning the channels from a node family of a trained neural network. Channel pruning process 900 may be implemented in the context of program instructions that, when executed by a suitable computing system, direct the processing circuitry of the computing system to operate as follows, referring parenthetically to the steps in FIG. 9. For the purposes of explanation, channel pruning process 900 will be explained with the elements of FIGS. 8A-8C. This is not meant to limit the applications of channel pruning process 900, but rather to provide an example.

To begin, processing circuitry associated with nodes 801, 807, 813, and 815 is configured to generate a net weight matrix for the corresponding channels of the node family (step 901). For example, the processing circuitry may generate five net weight matrices, such that the first net weight matrix represents the net weight matrix of matrices 802, 808, and 816, the second net weight matrix represents the net weight matrix of matrices 803, 809, and 817, the third net weight matrix represents the net weight matrix of matrices 804, 810, and 818, the fourth net weight matrix represents the net weight matrix of matrices 805, 811, and 819, and the fifth net weight matrix represents the net weight matrix of matrices 806, 812, and 820.

In an implementation, the net weight matrix for a set of corresponding channels is generated based on the number of output channels, the number of input channels, the matrix width, and the matrix height of the matrices from the channels. For example, to generate the net weight matrix for the first channel, the processing circuitry is configured to determine the number of output channels, the number of input channels, the matrix width, and the matrix height of matrices 802, 808, and 816. Then the processing circuitry is configured to determine the average number of input channels, the average matrix width, and the average matrix height for the matrices. Finally, the processing circuitry is configured to output the net weight matrix for matrices 802, 808, and 806 based on the number of output channels, the average number of input channels, the average matrix width, and the average matrix height for the matrices.

Next, the processing circuitry is configured to identify the smallest net weight matrix of the generated net weight matrices (step 903). For example, the processing circuitry may determine that the second and fourth net weight matrices are representative of the smallest net weight matrices. Once determined, the processing circuitry is configured to prune the channels which correspond to the smallest net weight matrices (step 905). For example, the processing circuitry may apply a hard mask to matrices 803, 805, 809, 811, 817, and 819 by multiplying the weights of the matrices by zero.

In an implementation, after pruning the data of nodes 801, 807, and 815, the processing circuitry is then configured to retrain the network based on the sparsified amount of channel weights. For example, after removing the second and fourth channels from nodes 801, 807, and 815, the processing circuitry is configured to retrain the network using the data from the first, third, and fifth channels.

Advantageously, channel pruning process 900 provides a technique for pruning the channels of a node family which takes into account corresponding channels across the node family. As a result, channel pruning process 900 provides a pruning method which generates an optimally fast network for when the network is deployed. In addition, channel pruning process 900 provides a technique for reducing the size of a trained neural network, thereby reducing the computational workload for when the network is deployed.

FIG. 10 illustrates results table 1000 in an implementation. Results table 1000 is representative of a table which depicts the accuracy loss of a network for when the network has been pruned via the channel structured pruning methodologies presented herein. More specifically, results table 1000 is representative of a table which depicts the accuracy loss of a network which was pruned to remove 30% of its channels via the channel structured pruning methodologies which are presented herein. Results table 1000 includes model column 1001, trained network accuracy column 1003, and proposed method accuracy column 1005.

Model column 1001 is representative of a column which depicts the types of models that associated processing circuitry may be configured to train and prune. For example, in a first implementation, the processing circuitry may be configured to train and prune a MobileNetv2 network. A MobileNetv2 network is representative of a lightweight convolutional neural network which is designed for mobile and embedded vision applications. Alternatively, in a second implementation, the processing circuitry may be configured to train and prune a Resnet50 network. A Resnet50 network is representative of a convolutional neural network which includes 50 layers and is configured to perform image classification. It should be noted that the advantages depicted by results table 1000 are not limited to the described networks, but for the purposes of explanation, Mobilenetv2 networks and Resnet50 networks will be discussed herein.

In an implementation, prior to the deployment of a MobileNetv2 network or a Resnet50 network, processing circuitry associated with the networks is configured to train the networks to perform a designated task. For example, the processing circuitry may train either network to perform image classification. Once trained, the processing circuitry may evaluate the trained network to determine if the network is accurately performing image classification, as depicted by trained network accuracy column 1003.

Trained network accuracy column 1003 is representative of a column which stores the accuracy percentage of a trained neural network which has not yet been pruned. For example, if a MobileNetv2 network was trained to perform image classification, and the MobileNetv2 network is capable of classifying images 71.88% of the time, then trained network accuracy column 703 is configured to store 71.88% for the MobileNetv2 network. Alternatively, if a Resnet50 network was trained to perform image classification, and the Resnet50 network is capable of classifying images 76.13% of the time, then trained network accuracy column 703 is configured to store 76.13% for the Resnet50 network.

In an implementation, after training a network to perform a designated task, processing circuitry associated with the network may identify the node families of the network, along with the corresponding channels of the node families, and for each node family, determine to prune the corresponding channels with the smallest net weight matrix. For example, the processing circuitry may be configured to execute channel pruning process 900. In an implementation, after pruning the corresponding channels of the node families, the processing circuitry is configured to evaluate the pruned neural network to determine if the network is still accurately performing its designated task, as depicted by proposed method accuracy column 1005.

Proposed method accuracy column 1005 is representative of a column which stores the accuracy percentage of a trained neural network which has been pruned via the proposed methodologies. For example, proposed method accuracy column 1005 may be representative of a column storing the accuracy percentage for a network which was pruned via channel pruning method 900. In an implementation, the accuracy percentage of a trained MobileNetv2 network which was pruned via the proposed methodologies decreases to 64.64%, while the accuracy percentage of a Resnet50 network which was pruned via the proposed methodologies decreases to 74.07%.

Advantageously, the proposed methodology for pruning channels of weights from the node families of a neural network provides a technique which minimizes the accuracy loss of the trained neural network. As a result, the proposed methodology provides a method for pruning the corresponding channels of a trained neural network which reduces the size of the neural network while minimizing the accuracy loss of the network.

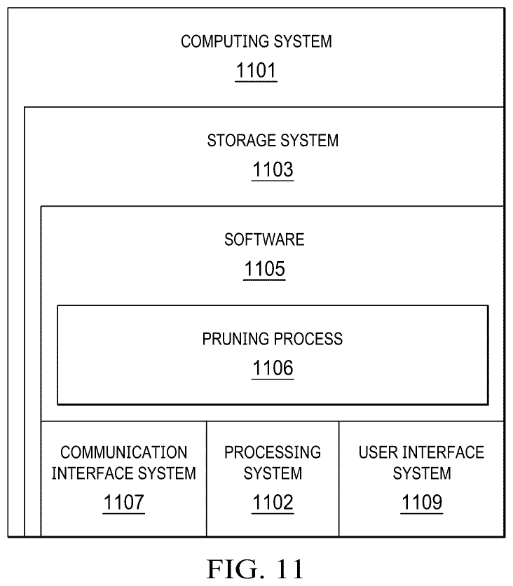

FIG. 11 illustrates an example computer system that may be used in various implementations. For example, computing system 1101 is representative of a computing device capable of efficiently pruning the data of a trained neural network as described herein. Computing system 1101 is representative of any system or collection of systems with which the various operational architectures, processes, scenarios, and sequences disclosed herein for pruning the channels of a neural network may be employed. Examples of computing system 1101 include—but are not limited to—micro controller units (MCUs), embedded computing devices, server computers, cloud computers, personal computers, mobile phones, and the like.

Computing system 1101 may be implemented as fa single apparatus, system, or device or may be implemented in a distributed manner as multiple apparatuses, systems, or devices. Computing system 1101 includes, but is not limited to, processing system 1102, storage system 1103, software 1105, communication interface system 1107, and user interface system 1109 (optional). Processing system 1102 is operatively coupled with storage system 1103, communication interface system 1107, and user interface system 1109. Computing system 1101 may be representative of a cloud computing device, distributed computing device, or the like.

Processing system 1102 loads and executes software 1105 from storage system 1103, or alternatively, runs software 1105 directly from storage system 1103. Software 1105 includes program instructions, which includes pruning process 1106 (e.g., pruning method 200, pruning process 500, channel pruning process 900). When executed by processing system 1102, software 1105 directs processing system 1102 to operate as described herein for at least the various processes, operational scenarios, and sequences discussed in the foregoing implementations. Computing device 1101 may optionally include additional devices, features, or functions not discussed for purposes of brevity.

Referring still to FIG. 11, processing system 1102 may comprise a micro-processor and other circuitry that retrieves and executes software 1105 from storage system 1103. Processing system 1102 may be implemented within a single processing device but may also be distributed across multiple processing devices or sub-systems that cooperate in executing program instructions. Examples of processing system 1102 include general purpose central processing units, graphical processing units, digital signal processing units, data processing units, application specific processors, and logic devices, as well as any other type of processing device, combinations, or variations thereof.

Storage system 1103 may comprise any computer readable storage media readable and writeable by processing system 1102 and capable of storing software 1105. Storage system 1103 may include volatile and nonvolatile, removable and non-removable, mutable and non-mutable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1103 may also include computer readable communication media over which at least some of software 1105 may be communicated internally or externally. Storage system 1103 may be implemented as a single storage device but may also be implemented across multiple storage devices or sub-systems co-located or distributed relative to each other. Storage system 1103 may comprise additional elements, such as a controller, capable of communicating with processing system 1102 or possibly other systems.

Software 1105 may be implemented in program instructions and among other functions may, when executed by processing system 1102, direct processing system 1102 to operate as described with respect to the various operational scenarios, sequences, and processes illustrated herein. In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1105 may include additional processes, programs, or components, such as operating system software, virtualization software, or other application software. Software 1105 may also comprise firmware or some other form of machine-readable processing instructions executable by processing system 1102.

In general, software 1105 may, when loaded into processing system 1102 and executed, transform a suitable apparatus, system, or device (of which computing device 1101 is representative) overall from a general-purpose computing system into a special-purpose computing system customized to support binary convolution operations. Indeed, encoding software 1105 (and pruning process 1106) on storage system 1103 may transform the physical structure of storage system 1103. The specific transformation of the physical structure may depend on various factors in different implementations of this description. Examples of such factors may include, but are not limited to, the technology used to implement the storage media of storage system 1103 and whether the computer-storage media are characterized as primary or secondary, etc.

For example, if the computer readable storage media are implemented as semiconductor-based memory, software 1105 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1107 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1101 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method for pruning a neural network, wherein the neural network includes multiple nodes, and wherein each node includes one or more channels, and wherein the method comprises, for at least a channel:
identifying weights to prune from the channel;
determining a pruning factor; and
reducing each of the identified weights over multiple training epochs using the pruning factor.

2. The method of claim 1, further comprising:
determining that a first weight of the identified weights satisfies a threshold value; and
removing the first weight from the channel.

3. The method of claim 1, wherein identifying the weights to prune further comprises:
determining a sparsity target for the channel, wherein the sparsity target comprises a target share of weights to prune from the channel;
determining a weight threshold based on the sparsity target; and
identifying the weights using the weight threshold.

4. The method of claim 3, further comprising:
receiving a user input;
determining the sparsity target based on the user input; and
determining the pruning factor based on the user input.

5. The method of claim 1, wherein the pruning factor is determined based on a current epoch of the multiple training epochs, an initial epoch of the multiple training epochs, and a final epoch of the multiple training epochs.

6. The method of claim 1, wherein the pruning factor is a number greater than or equal to zero, and less than or equal to one.

7. The method of claim 1, wherein reducing the identified weights further comprises, over each of the multiple training epochs, multiplying each of the identified weights by the pruning factor.

8. The method of claim 1, wherein the pruning factor is associated with a desired pace at which to reduce the identified weights to zero.

9. The method of claim 1, wherein a value of the pruning factor is dynamic over the multiple training epochs.

10. The method of claim 1,
wherein reducing each of the identified weights comprises reducing a weight by a percentage, and
wherein the percentage increases as training progresses through the multiple training epochs.

11. The method of claim 1, further comprising:
generating a net weight matrix for each corresponding channel in a node family of the neural network, wherein the node family includes two or more connected nodes;
selecting corresponding channels of the node family using the net weight matrix for each corresponding channel in the node family; and
pruning the selected corresponding channels.

12. A non-transitory computer-readable medium having executable instructions stored thereon, configured to be executable by processing circuitry for causing the processing circuitry to, for at least a channel of a neural network:
identify weights to prune from the channel;
determine a pruning factor; and
reduce each of the identified weights over multiple training epochs using the pruning factor.

13. The non-transitory computer-readable medium of claim 12, wherein the instructions are executable by the processing circuitry for further causing the processing circuitry to:
determine that a first weight of the identified weights satisfies a threshold value; and
remove the first weight from the channel.

14. The non-transitory computer-readable medium of claim 12, wherein to identify the weights to prune, the instructions are executable by the processing circuitry for further causing the processing circuitry to:
determine a sparsity target for the channel, wherein the sparsity target comprises a target share of all weights to prune from the channel;
determine a weight threshold based on the sparsity target; and
identify the weights based on the weight threshold.

15. The non-transitory computer-readable medium of claim 14, wherein the instructions are executable by the processing circuitry for further causing the processing circuitry to:
receive user input;
determine the sparsity target based on the user input; and
determine the pruning factor based on the user input.

16. The non-transitory computer-readable medium of claim 12, wherein the pruning factor is determined based on a current epoch of the multiple training epochs, an initial epoch of the multiple training epochs, and a final epoch of the multiple training epochs, wherein the pruning factor is associated with a desired pace at which to reduce the identified weights to zero, and wherein the pruning factor is a number which is greater than or equal to zero, and less than or equal to one.

17. The non-transitory computer-readable medium of claim 12, wherein to reduce the identified weights, the instructions are executable by the processing circuitry for further causing the processing circuitry to, over each of the multiple training epochs, multiply each of the identified weights by the pruning factor.

18. The non-transitory computer-readable medium of claim 12, wherein the instructions are executable by the processing circuitry for further causing the processing circuitry to:
generate a net weight matrix for each corresponding channel in a node family of the neural network, wherein the node family includes two or more connected nodes;
select corresponding channels of the node family using the net weight matrix for each corresponding channel in the node family; and
prune the selected corresponding channels.

19. A system comprising:
a memory configured to store a neural network, wherein the neural network includes multiple nodes, and wherein each node includes one or more channels; and
processing circuitry coupled to the memory and configured to, for at least a channel:
identify weights to prune from the channel;
determine a pruning factor, wherein the pruning factor is associated with a desired pace at which to reduce the identified weights to zero, and wherein the pruning factor is a number which is greater than or equal to zero, and less than or equal to one;
reduce each of the identified weights over multiple training epochs using the pruning factor; and
over the multiple training epochs, remove the identified weights which have been reduced to below a threshold value.

20. The system of claim 19, wherein the processing circuitry is further configured to:
generate a net weight matrix for each corresponding channel in a node family of the neural network, wherein the node family includes two or more connected nodes;
select corresponding channels of the node family using the net weight matrix for each corresponding channel in the node family; and
prune the selected corresponding channels.
